(19) United States
(12) Patent Application Publication
(10) Pub. No.: US 2025/0313417 A1
(43) Pub. Date: Oct. 9, 2025

(54) PICK AND PLACE SYSTEM FOR LOGISTICS APPLICATIONS

(71) Applicant: B&R Industrial Automation GmbH, Eggelsberg (AT)

(72) Inventors: Derrick Stacey, Atlanta, GA (US); Dario Rovelli, Valbrembo (IT)

(21) Appl. No.: 18/980,111

(22) Filed: Dec. 13, 2024

(30) Foreign Application Priority Data
Apr. 4, 2024 (EP) 24168453.9

(51) Int. Cl. B65G 47/61; B65G 54/02

(52) U.S. Cl. CPC B65G 47/61; B65G 54/02; B65G 2203/044

(57) ABSTRACT

An improved pick and place system is disclosed. The system minimizes the pick and place distance and the size of a manipulator, increases operation speed of the pick and place system, and uses a planar motor to serve as an outfeed conveyor. The outfeed planar motor is designed to synchronize the movement of the shuttle of the outfeed planar motor in the transfer zone to an infeed movement trajectory of the at least one product in the transfer zone at least when the manipulator picks the at least one product off the infeed conveyor. An infeed planar motor is designed to synchronize the movement of the shuttle of the infeed planar motor in the transfer zone to an outfeed movement trajectory of the at least one product in the transfer zone at least when the manipulator picks the at least one product off the shuttle of the infeed planar motor.

### CROSS-REFERENCE TO RELATED APPLICATIONS

The present application claims priority to European Patent Application No. 24168453.9 filed on Apr. 4, 2024, and titled “PICK AND PLACE SYSTEM FOR LOGISTICS APPLICATIONS”, which is hereby incorporated by reference in its entirety.

### TECHNICAL FIELD

The present disclosure pertains to a pick and place system for transferring products, comprising: a manipulator, an infeed conveyor and an outfeed conveyor, wherein at least the infeed conveyor or the outfeed conveyor is designed as a planar motor comprising at least one shuttle, which at least one shuttle is moveable in a transfer zone of the pick and place system, wherein when the pick and place system is used, at least one product is arranged on the infeed conveyor and the at least one product is conveyed by the infeed conveyor into the transfer zone, wherein the manipulator is moveable in the area of the transfer zone and the manipulator is provided to pick the at least one product off the infeed conveyor, to move the at least one product to the outfeed conveyor and to place the at least one product onto the outfeed conveyor during a transfer time when the pick and place system is used. The present disclosure also pertains to a method for operating a pick and place system for transferring products.

### BACKGROUND

Rapid growth in product processing industries, like food and beverage, call for more efficient and flexible product handling systems to increase product flow and minimizing manual labor. To satisfy the needs of those industries, so-called pick and place systems are widely used, which are automated systems for handling products during different processing steps, like sorting or packaging of products.

Pick and place systems basically comprise a manipulator (e.g., a robot, robotic arm or a delta robot with a gripper) and a number of conveyors (e.g., belt conveyors), which are designed to convey certain products (e.g., pieces of food, packages, etc.). The manipulator is arranged in the area of the conveyors and is used to transfer products from one conveyor to another conveyor, for example, from an infeed conveyor to an outfeed conveyor. Therefore, the manipulator picks off a product from one conveyor and places the picked-off product onto another conveyor, e.g., in a sorted manner. The product must not be conveyed directly on the conveyor but the product could also be picked from a given receptacle on the conveyor, for example a container or a box. Likewise, placing must not be directly onto the conveyor but the product could be placed into given receptacles on the conveyor.

To optimize the efficiency of pick and place systems, sophisticated pick strategies are used to allow multiple manipulators to work with minimal overlap to maximize pick range and minimize missed products, for example, as they are randomly presented on the conveyors.

Depending on the volume of the product flow as well as the size of the products, the conveyors and thus the workspaces of the manipulators can be quite large.

The main drawback of current state of the art pick and place systems is to manage trade-offs between size and number of manipulators. For a high volume of smaller products, an increase in the number of manipulators is needed to ensure a certain operation speed of the pick and place system. As a result, the complexity of the pick strategy increases, which induces higher automation costs.

For heavier products larger manipulators are needed, which increase the cost of the pick and place system due to enlarged arm linkage size, gearbox size and motor size of the manipulators. This increase in size also impacts the operation speed of the manipulators itself due to higher inertia that needs to be moved, especially when pick and place distances for the manipulators are quite far.

In recent years the development of planar transportation technology, like planar motors, has enabled more flexibility and more complex movement profiles in logistics applications. Besides horizontal usage of planar motors, there are also arrangements known for vertical and overhead operation, which enables even more flexibility. Planar motors are well known in prior art. U.S. Pat. No. 9,202,719 B2, for example, discloses the basic structure and the mode of operation of a planar motor. Basically, a planar motor has a stator which forms a movement plane above an active surface of the stator. One or more movable devices, so-called shuttles, can be moved mainly in two dimensions in the movement plane formed by the stator, whilst levitating above the active surface of the stator. With the aid of such planar motors, high-precision movements of the levitating shuttles can be carried out in the direction of all six rigid body degrees of freedom.

In U.S. Pat. No. 10,173,848 B2 a planar motor with a number of shuttles is used for transferring products between transportation systems, e.g., belt conveyors, without the use of a manipulator. Therein, a belt conveyor is arranged between the active surface of the stator and the number of shuttles of the planar motor. This arrangement enables movement of the shuttles above the belt conveyor, which can then shove the products conveyed on the belt conveyor.

### BRIEF DESCRIPTION

It is an object of the present disclosure to provide an improved pick and place system, wherein the required pick and place distance and the size of the manipulator is minimized and operation speed of the pick and place system is increased.

This object is achieved with the features of the independent claims. The present disclosure proposes a pick and place system comprising at least one planar motor.

The outfeed conveyor is designed as planar motor, wherein when the pick and place system is used, the at least one product is conveyed on the infeed conveyor into the transfer zone with a given infeed movement trajectory and the shuttle of the outfeed planar motor is moved in the transfer zone in the region of the at least one product on the infeed conveyor, wherein the outfeed planar motor is designed to synchronize the movement of the shuttle of the out-feed planar motor in the transfer zone to the infeed movement trajectory of the at least one product in the transfer zone at least when the manipulator picks the at least one product off the infeed conveyor. Due to the movement synchronization of the shuttle of the outfeed planar motor and the at least one product on the infeed conveyor in the transfer zone, the complexity of the movement of the manipulator necessary to transfer the product to the outfeed conveyor can be significantly decreased. Furthermore, by moving the shuttle in the region of the at least one product on the infeed conveyor, the pick and place distance for the manipulator is minimized. This leads to a cascading effect, since due to the minimized pick and place distance, the size of the manipulator can be reduced and the operation speed of the pick and place system can be increased. In this way the transfer time for the manipulator to transfer the at least one product from the infeed conveyor onto outfeed conveyor is decreased as well.

Alternatively, the infeed conveyor is designed as planar motor and the shuttle of the infeed planar motor is designed to convey the at least one product into the transfer zone, wherein when the pick and place system is used, the at least one product is conveyed by the outfeed conveyor out of the transfer zone with a given outfeed movement trajectory after being placed onto the outfeed conveyor by the manipulator, wherein the infeed planar motor is designed to synchronize the movement of the shuttle of the infeed planar motor in the transfer zone to the outfeed movement trajectory of the at least one product in the transfer zone at least when the manipulator picks the at least one product off the shuttle of the infeed planar motor. Also in this embodiment, the pick and place distance for the manipulator can be minimized, the size of the manipulator can be reduced and the operation speed of the pick and place system can be increased. Due to the fact, that either the infeed conveyor or the out-feed conveyor is designed as planar motor, the proposed pick and place system can be used in a variety of different applications, which enhances the flexibility of said pick and place system.

In an advantageous embodiment, the outfeed planar motor is designed to synchronize the movement of the shuttle of the outfeed planar motor in the transfer zone to the infeed movement trajectory of the at least one product in the transfer zone when the pick and place system is used for a given synchronizing time before the manipulator picks the at least one product off the infeed conveyor. Alternatively, the infeed planar motor is designed to synchronize the movement of the shuttle of the infeed planar motor in the transfer zone to the out-feed movement trajectory of the at least one product in the transfer zone when the pick and place system is used for a given synchronizing time before the manipulator picks the at least one product off the shuttle of the infeed planar motor. In this way, the pick and place distance for the manipulator can be minimized ahead, since the movements of the respective shuttle and the respective movement trajectory are already synchronized before the manipulator begins to transfer the at least one product.

In some embodiments, the outfeed planar motor is designed to synchronize the movement of the shuttle of the outfeed planar motor in the transfer zone to the movement of the manipulator in the transfer zone at least for a given transfer synchronizing time during the transfer time after the manipulator has picked off the at least one product when the pick and place system is used. Alternatively, the infeed planar motor is designed to synchronize the movement of the shuttle of the infeed planar motor in the transfer zone to the movement of the manipulator in the transfer zone at least for a given transfer synchronizing time during the transfer time after the manipulator has picked off the at least one product when the pick and place system is used. Since relative movement of the respective shuttle and the manipulator during the transfer time has a significant influence on the (ultimately) required pick and place distance, synchronizing the movements of the respective shuttle and the manipulator can help decreases said distance as well as the transfer time.

In yet another embodiment, the pick and place system further comprises a control unit, which is designed to control the movement of the manipulator and/or the movement of the shuttle of the infeed planar motor and/or the movement of the shuttle of the outfeed planar motor in the transfer zone.

The present disclosure further proposes a method, wherein the outfeed conveyor is designed as planar motor and the at least one product is conveyed on the infeed conveyor into the transfer zone with a given infeed movement trajectory, wherein the shuttle of the outfeed planar motor is moved in the transfer zone in the region of the at least one product on the infeed conveyor, wherein the movement of the shuttle of the outfeed planar motor in the transfer zone is synchronized to the infeed movement trajectory of the at least one product in the transfer zone at least when the manipulator picks the at least one product off the infeed conveyor. Alternatively, the infeed conveyor is designed as planar motor and the at least one product is conveyed on the shuttle of the infeed planar motor into the transfer zone and the at least one product is conveyed by the outfeed conveyor out of the transfer zone with a given outfeed movement trajectory after being placed onto the outfeed conveyor by the manipulator, wherein the movement of the shuttle of the infeed planar motor in the transfer zone is synchronized to the outfeed movement trajectory of the at least one product in the transfer zone at least when the manipulator picks the at least one product off the shuttle of the infeed planar motor. Due to the movement synchronization of the respective shuttle and the at least one product on the infeed conveyor in the transfer zone, the movement of the manipulator necessary to transfer the product to the outfeed conveyor can be significantly simplified. Furthermore, since the shuttle is moved in the region of the at least one product on the infeed conveyor, the pick and place distance for the manipulator is minimized. As the pick and place distance is reduced, the size of the manipulator can be reduced as well, which enables increasing the operation speed of the pick and place system. The transfer time for the manipulator to transfer the at least one product from the infeed conveyor onto outfeed conveyor is significantly reduced compared to known pick and place systems.

In some embodiments, the movement of the shuttle of the outfeed planar motor in the transfer zone is synchronized to the infeed movement trajectory of the at least one product in the transfer zone for a given synchronizing time before the manipulator picks the at least one product off the infeed conveyor. Alternatively, the movement of the shuttle of the infeed planar motor in the transfer zone is synchronized to the outfeed movement trajectory of the at least one product in the transfer zone for a given synchronizing time before the manipulator picks the at least one product off the shuttle of the infeed planar motor. Since the movements of the respective shuttle and the respective movement trajectory are already synchronized before the manipulator begins to transfer the at least one product, the required pick and place distance can be minimized ahead.

Advantageously, after the manipulator has picked off the at least one product, during the transfer time the movement of the shuttle of the infeed planar motor or the movement of the shuttle of the outfeed planar motor in the transfer zone is synchronized to the movement of the manipulator in the transfer zone at least for a given transfer synchronizing time. As the relative movement of the respective shuttle and the manipulator during the transfer time has a significant influence on the (ultimately) required pick and place distance, synchronizing the movements of the respective shuttle and the manipulator reduces said distance as well as the transfer time.

In addition, during the transfer synchronizing time the shuttle of the outfeed planar motor is moved towards the manipulator in the transfer zone or during the transfer synchronizing time the shuttle of the infeed planar motor is moved away from the manipulator in the transfer zone. In this way, the pick and place distance is reduced even further, which further decreases the transfer time and in turn increases operation speed of pick and place system.

In some embodiments, the outfeed conveyor is designed as planar motor and the infeed conveyor is designed as planar motor, wherein an outfeed shuttle bounding shape is defined for the shuttle of the outfeed planar motor, said outfeed shuttle bounding shape encompasses the shuttle of the outfeed planar motor, and an infeed shuttle bounding shape is defined for the shuttle of the infeed planar motor, said infeed shuttle bounding shape encompasses the shuttle of the infeed planar motor and in that during the transfer time a shuttle distance between the out-feed shuttle bounding shape and the infeed shuttle bounding shape is kept between a given minimum pick-and-place distance and a given maximum pick-and-place distance, wherein in some embodiments said shuttle distance is between zero and a largest extension in one direction of the outfeed shuttle bounding shape or the infeed shuttle bounding shape. This ensures, that while the at least one product is transferred, the required pick and place distance is minimized.

Alternatively, the outfeed conveyor is designed as planar motor, wherein an outfeed shuttle bounding shape is defined for the shuttle of the outfeed planar motor, said outfeed shuttle bounding shape encompasses the shuttle of the outfeed planar motor with a pick distance between the outer circumference of the shuttle of the outfeed planar motor and the outfeed shuttle bounding shape so that a product zone is formed between the outer circumference of the shuttle of the outfeed planar motor and the outfeed shuttle bounding shape, wherein in some embodiments said pick distance is maximum a largest extension in one direction of the shuttle of the outfeed planar motor, and in that the movement of the shuttle of the outfeed planar motor and/or the movement of the manipulator is controlled to keep the at least one product in the product zone during the transfer time. This also helps to significantly decrease the required pick and place distance and the transfer time.

In addition, the shuttle of the outfeed planar motor is moved towards the at least one product in the product zone before the manipulator picks the at least one product off the infeed conveyor in said product zone and wherein after the at least one product is picked off the infeed conveyor by the manipulator, the manipulator places the at least one product onto the shuttle of the outfeed planar motor. In that way, the transfer time and the required pick and place distance is even further minimized.

Alternatively, the infeed conveyor is designed as planar motor, wherein an infeed shuttle bounding shape is defined for the shuttle of the infeed planar motor, said infeed shuttle bounding shape encompasses the shuttle of the infeed planar motor with a place distance between the outer circumference of the shuttle of the infeed planar motor and the infeed shuttle bounding shape so that a product zone is formed between the outer circumference of the shuttle of the infeed planar motor and the infeed shuttle bounding shape, wherein in some embodiments said place distance is maximum a largest extension in one direction of the shuttle of the infeed planar motor, and in that the movement of the shuttle of the infeed planar motor and/or the movement of the manipulator is controlled to keep the at least one product in the product zone during the transfer time. Hence, the at least one product is transferred in the product zone, minimizing the required pick and place distance can be ensured.

In some embodiments, in the transfer zone the movement of the manipulator and/or the movement of the shuttle of the infeed planar motor and/or the movement of the shuttle of the outfeed planar motor is controlled by a control unit of the pick and place system.

### BRIEF DESCRIPTION OF DRAWINGS

The present disclosure is described in greater detail in the following with reference to FIGS. 1 to 4, which show exemplary, schematic and non-limiting advantageous embodiments of the disclosure. In the drawings:

FIG. 1 shows the basic components of a pick and place system;

FIG. 2 shows a side view of the pick and place system;

FIG. 3 shows an alternative embodiment of a pick and place system; and

FIG. 4 shows another alternative embodiment of a pick and place system.

### DETAILED DESCRIPTION

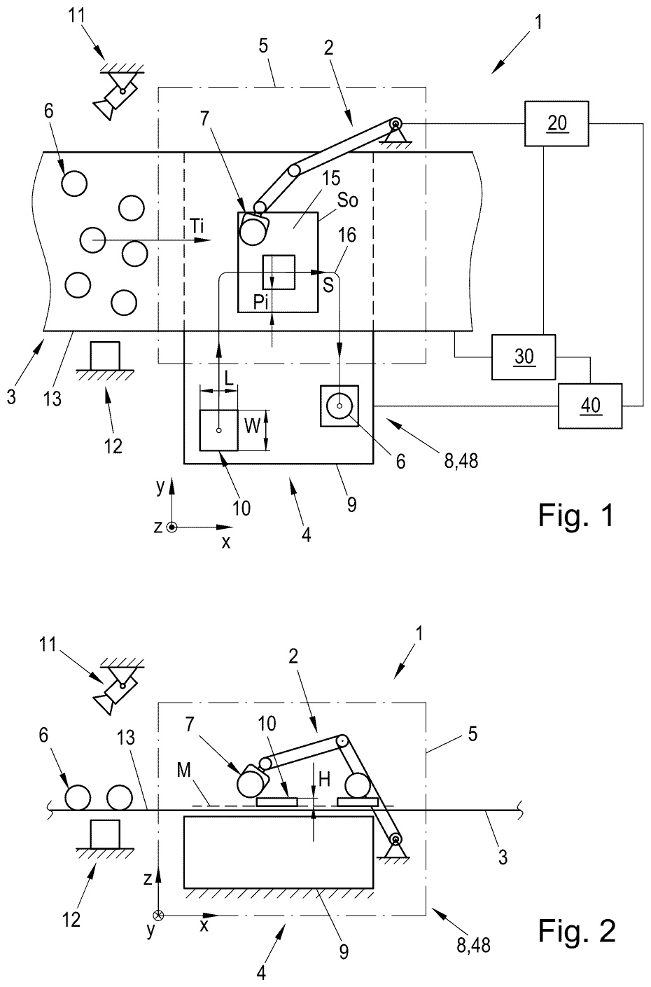

FIG. 1 shows an exemplarily embodiment of a pick and place system 1 according to the present disclosure in a horizontal arrangement viewed from above. The pick and place system 1 comprises a manipulator 2, an infeed conveyor 3 and an outfeed conveyor 4. The pick and place system 1 is used for transferring products 6 from the infeed conveyor 3 to the outfeed conveyor 4. The pick and place system 1 can be used in a variety of different product processing industries, like food and beverage, or in logistics, like in a package logistic center, etc. Depending on the application of the pick and place system 1, a variety of different or identical types of products 6 can be conveyed and transferred, for example, pieces of food or some kind of packing means like packages or boxes, etc.

When the pick and place system 1 is used, at least one product 6 is arranged on the infeed conveyor 3 and the at least one product 6 is conveyed by the infeed conveyor 3 into a transfer zone 5 of the pick and place system 1. For example, the at least one product 6 can be conveyed directly on the infeed conveyor 3 or the at least one product 6 is conveyed in a given receptacle on the infeed conveyor 3, for example, in some sort of a container or box.

The manipulator 2 is arranged in the pick and place system 1, so that the manipulator 2, at least a gripper 7 of the manipulator, is moveable in the area of the transfer zone 5. In said transfer zone 5 the manipulator 2 transfers the at least one product 6, which is conveyed by the infeed conveyor 3, to the outfeed conveyor 4. Therefore, the transfer zone 5 encompasses at least parts of the infeed conveyor 3 and the outfeed conveyor 4, between which parts the at least one product 6 can be transferred by the manipulator 2. In a possible embodiment, the infeed conveyor 3 and the outfeed conveyor 4 overlap at least in parts (as in FIG. 1). As shown in FIG. 1, in some embodiments the transfer zone 5 encompasses an intersection, where the infeed conveyor 3 and the outfeed conveyer 4 overlap. Of course, the infeed conveyor 3 and the outfeed conveyor 4 can also be arranged in a different way in the transfer zone 5, for example, next to each other or adjoining, and especially also non-overlapping.

The manipulator 2 is moveable in the area of the transfer zone 5, which means that the manipulator 2 is provided to pick the at least one product 6 off the infeed conveyor 3, to move the at least one product 6 to the outfeed conveyor 4 and to place the at least one product 6 onto the outfeed conveyor 4 during a transfer time, when the pick and place system 1 is used. After that, the at least one product 6 is conveyed out of the transfer zone 5 by the out-feed conveyor 4. For example, the at least one product 6 can be conveyed directly on the outfeed conveyor 4 or the at least one product 6 is conveyed in a given receptacle on the outfeed conveyor.

The transfer zone 5 merely serves for describing the present disclosure and is indicated with a dash-dotted line in the figures in an exemplary Cartesian coordinate system having a x-direction, a y-direction and a z-direction. The transfer zone 5 is basically limited by the possible range of movement of the manipulator 2, especially of the gripper 7 of the manipulator 2.

In some embodiments, the manipulator 2 is designed as a single or multiple axis manipulator like a robot, robotic arm, a delta robot, etc. In FIG. 1 the manipulator 2 is exemplary shown as a robotic arm. Furthermore, in some embodiments, the manipulator 2 comprises a gripper 7, which is designed to grip the at least one product 6 and to pick off the at least one product 6 from the infeed conveyor 3 in the transfer zone 5. Depending on the type of the at least one product 6, different types and sizes of the manipulator 2 and the gripper 7 can be used. Any device that can hold the product is to be seen as gripper 7 in the sense of the present disclosure. In some embodiments, the manipulator 2 comprises a manipulator control unit 20 (e.g., a microcontroller), which controls the movement of the manipulator 2, especially of the gripper 7. The manipulator control unit 20 can also control the actuation of the gripper 7 of the manipulator 2. In FIG. 1 the manipulator control unit 20 is only indicated schematically. In addition, a number of sensors (not shown) can be used for controlling the manipulator 2 and the gripper 7. The movement of the manipulator 2 includes a direction of movement in space (e.g., in x-y-z direction) and a speed in said direction of movement.

The infeed conveyor 3 and the outfeed conveyor 4 can either be designed as a planar motor 8 or as a known industrial conveyor, like an endless conveyor, like a belt conveyor, a roller conveyor, a chain conveyor, etc. Depending on the type of the industrial conveyor, different conveying means 13 can be used on which the at least one product 6 is arranged and by which the at least one product 6 is conveyed. In FIG. 1, the infeed conveyor 3 is designed as a known belt conveyor (not entirely shown in FIG. 1 and FIG. 2), having a belt as the conveying means 13. For example, the at least one product 6 is arranged on the belt of the belt conveyor as the infeed conveyor 3.

The infeed conveyor 3 is configured to convey the at least one product 6 by the conveying means 13 into the transfer zone 5 with a given infeed movement trajectory Ti. The infeed movement trajectory Ti defines a direction of movement (path) and a conveying speed (dynamics) in said direction of movement of the at least one product 6 on the infeed conveyor 3. To convey the at least one product 6 into the transfer zone 5, the conveying means 13 of the industrial conveyor as the infeed conveyor 3 can be actively driven by a drive unit (not shown), for example, an electric motor. The drive unit can be controlled by a conveyor control unit 30 (e.g., a microcontroller). The conveyor control unit 30 may control the conveying speed of the conveying means 13, for example. In FIG. 1 the conveyor control unit 30 is only indicated schematically. Of course, the present disclosure is not limited to actively driven types of industrial conveyors. Also passively driven industrial conveyors can be used, for example, wherein the at least one product 6 is moved by gravity. In FIG. 1, the infeed trajectory Ti exemplarily indicates a movement of the at least one product 6 along a known movement direction of the infeed conveyor 3 into the transfer zone 5 in x-direction with a known conveying speed of the conveying means 13 in said x-direction. The conveying speed of the at least one product 6 is not limited to a constant conveying speed along the movement trajectory. The conveying speed of the at least one product 6 can also be changing along said movement trajectory. For example, in case of a passively driven industrial conveyor, the at least one product 6 can be accelerated or decelerated along the movement trajectory.

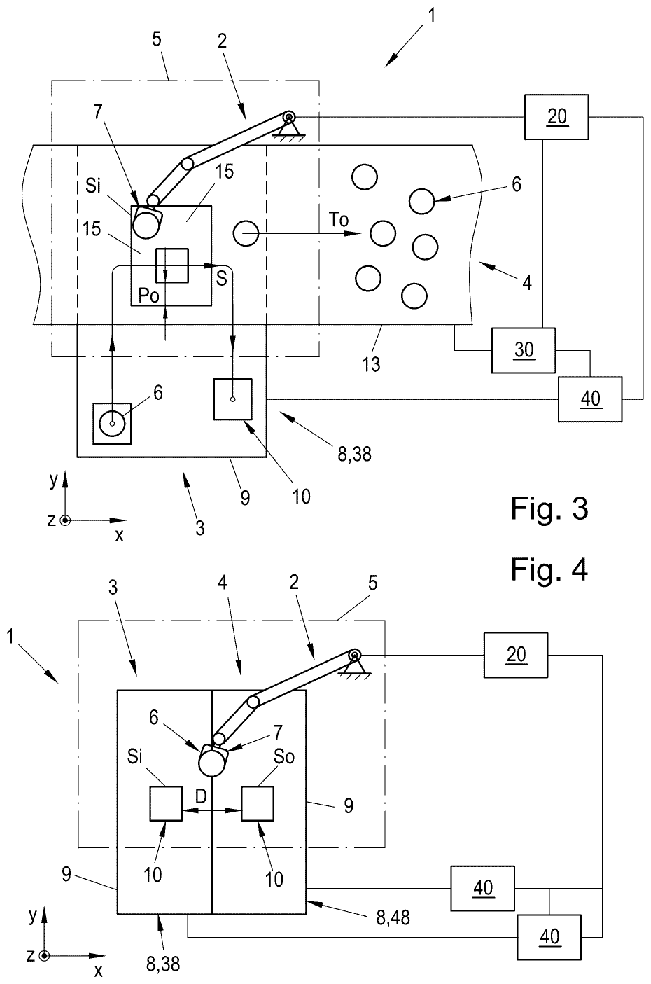

According to the present disclosure, at least the infeed conveyor 3 or the outfeed conveyor 4 is designed as planar motor 8. In the embodiment shown in FIG. 1 and FIG. 2, the outfeed conveyor 4 is configured as planar motor 8 and is therefore described as outfeed planar motor 48. If the infeed conveyor 3 is configured as planar motor 8, it is described in the following as infeed planar motor 38, which will be described in detail in the following with FIG. 3. It is also possible that both the infeed conveyor 3 and the outfeed conveyor 4 are designed as planar motor 8, which will be described in the following with FIG. 4.

As mentioned at the beginning, basically the planar motor 8 comprises a stator 9 and at least one shuttle 10. The stator 9 of the planar motor 8 can comprise a modular structure, in that the stator 9 comprises two or more stator segments. The stator segments can be connected in virtually any pattern necessary for the respective application of the planar motor 8. In the following description of the proposed pick and place system 1, the stator 9 is described as one single structure having, e.g., a rectangular shape. Of course, the stator 9 is not limited to the geometric shape shown in the figures.

In the following only one shuttle 10 per planar motor 8 is described. Of course, the proposed pick and place system 1 can comprise more than one shuttle 10 per planar motor 8 that can be moved simultaneously and independent form each other with the planar motor 8.

The stator 9 of the planar motor 8 defines a movement plane M for the shuttle 10 above an active surface of the stator 9. For example, the movement plane M can expand in the x-y plane, at a certain height in the z-direction above the active surface of the stator 9, as exemplarily indicated in FIG. 2 by a dash dotted line. The term “active surface” describes a surface of the stator 9 above which the shuttle 10 can be moved by electromagnetic forces in a known manner. The at least one shuttle 10 can levitate in the movement plane M above the active surface of the stator 9 and is generally moveable in at least two directions of movement. For example, the shuttle 10 can be moved in the movement plane M in x- and y-direction. The shuttle 10 can also be moved in z-direction by adjusting the height of levitation above the stator 9 by lowering or raising the movement plane M, also for each shuttle independently. Furthermore, the shuttle 10 can rotate about its rotational axes. As mentioned at the beginning, the shuttle 10 can be basically moved above the active surface of the stator 9 in the direction of all six rigid body degrees of freedom. However, for the sake of simplicity, the present disclosure is further explained by two directions of movement of the shuttle 10 in x-and y-direction. Since the function and structure of a planar motor 8 are known, there will be no detailed description of the stator 9 and the shuttle 10 at this point. For controlling the movement of the shuttle 10, especially in the transfer zone 5, the planar motor 8 can comprise a planar motor control unit 40 (e.g., a microcontroller). The conveyor control unit 30 is only indicated schematically in FIG. 1.

However, as mentioned at the beginning, the stator 9 is not restricted to a horizontal arrangement, e.g., in the x-y plane, as shown in the figures. The stator 9 can also be arranged in a vertical arrangement, e.g., to form the movement plane M in the x-z or y-z plane. Furthermore, an overhead arrangement of the stator 9 is also possible, in that the movement plane Min the x-y plane is suspended in negative z-direction from the active surface of the stator 9. For the sake of simplicity, in the following the present disclosure will be described with the horizontal arrangement of the stator 9, wherein the movement plane M is in the x-y plane.

The shuttle 10 of the planar motor 8 can be designed in different shapes, e.g., rectangular, circular, etc. The shuttle 10 can also be designed in different sizes (extensions in x-, y- and z-direction). For example, the size of the shuttle 10 can depend on the size of the at least one product 6 to be conveyed. As shown in the figures, the shuttle 10 has a rectangular (boxy) shape with an extension in x-direction (length L), an extension in y-direction (width W) and an extension in z-direction (height H). Usually, the width W and the length L of the shuttle is substantially larger than its height H.

Due to the levitation of the shuttle 10 above the active surface of the stator 9 of the planar motor 8, an air gap is present. In some embodiments, the conveying means 13 of the industrial conveyor is arranged in the air gap between the levitating shuttle 10 and the active surface of stator 9. FIG. 2 shows a side view of an embodiment of the pick and place system 1, wherein the outfeed conveyor 4 is designed as the planar motor 8 and the infeed conveyor 3 is designed as belt conveyor. The shuttle 10 of the outfeed planar motor 48 is levitating above the stator 9 of the outfeed planar motor 48. As exemplarily shown in FIG. 2, the belt as the conveying means 13 can be at least partially arranged in the air gap between the shuttle 10 and the active surface of the stator 9 of the outfeed planar motor 48. In that way the at least one product 6, which is arranged on the conveying means 13, can be conveyed into the transfer zone 5 and the shuttle 10 can be moved above the conveying means 13 and therefore in the region of the at least one product 6 on the conveying means 13 in the transfer zone 5, when the pick and place system 1 is used. Although in FIG. 2 the outfeed conveyor 4 is designed as planar motor 8, the same arrangement can be achieved with the infeed planar motor 38, as shown in FIG. 3, wherein the outfeed conveyor 4 is designed as belt conveyor and the infeed conveyor 3 is designed as the planar motor 8.

As shown in FIG. 1, when the pick and place system 1 is used, the at least one product 6 is conveyed on the infeed conveyor 3 into the transfer zone 5 with the given infeed movement trajectory Ti and the shuttle 10 of the outfeed planar motor 48 is moved in the transfer zone 5 in the region of the at least one product 6 on the infeed conveyor 3. The infeed movement trajectory Ti is exemplarily indicated in FIG. 1 as a vector. As the shuttle 10 of the outfeed planar motor 48 is moved in the transfer zone 5, the shuttle 10 has a certain direction of movement and speed in said direction of movement, for example in x-y direction, which is indicated in FIG. 1 with a shuttle vector S. The shuttle 10 of the outfeed planar motor 48 can be moved, for example, along a certain conveying path 16 into the transfer zone 5 and out of the transfer zone 5. The conveying path 16 is only exemplary indicated in FIG. 1 in the x-y plane. Since the shuttle 10 of the outfeed planar motor 48 can be moved in the movement plane M in various movement directions, the movement of the shuttle 10 in the transfer zone 5, as well as into or out of the transfer zone 5, can be given essentially without any restrictions.

The outfeed planar motor 48 is designed to synchronize the movement of the shuttle 10 of the outfeed planar motor 48 in the transfer zone 5 to the infeed movement trajectory Ti of the at least one product 6 in the transfer zone 5 at least when the manipulator 2 picks the at least one product 6 off the infeed conveyor 3. In some embodiments, the outfeed planar motor 48 is designed to synchronize the movement of the shuttle 10 of the outfeed planar motor 48 in the transfer zone 5 to the infeed movement trajectory Ti of the at least one product 6 in the transfer zone 5 for a given synchronizing time, before the manipulator 2 picks the at least one product 6 off the infeed conveyor 3. The synchronizing time can depend on the conveying speed of the conveying means 13. For example, the synchronizing time can be chosen to make sure that the movement of the shuttle 10 and infeed movement trajectory Ti of the at least one product 6 are synchronized, when the at least one product 6 is entering the transfer zone 5.

Furthermore, in some embodiments, the outfeed planar motor 48 is designed to synchronize the movement of the shuttle 10 of the outfeed planar motor 48 in the transfer zone 5 to the movement of the manipulator 2 in the transfer zone 5 at least for a given transfer synchronizing time during the transfer time after the manipulator 2 has picked off the at least one product 6, when the pick and place system 1 is used. For example, the transfer synchronizing time can be equal to the transfer time. Therefore, after the manipulator 2 has transferred the at least one product 6 to the shuttle 10 of the outfeed planar motor 48, said shuttle 10 with the at least one product 6 can be moved out of the transfer zone 5 independently of the movement of the manipulator 2.

The term “synchronize” basically means in this context, to control the movement of the shuttle 10 of the outfeed planar motor 48 to achieve a predefined relative movement between said shuttle 10 and the infeed movement trajectory Ti of the at least one product 6 in the transfer zone 5. In some embodiments, the shuttle 10 of the outfeed planar motor 48 and the at least one product 6 move relative to each other in approximately the same direction and at approximately the same speed in the transfer zone 5. For example, during the synchronizing time, the speed of the shuttle 10 is therefore controlled to be approximately the same as the conveying speed of the at least one product 6 on the infeed conveyor 3. As already mentioned, the present disclosure is not limited to a constant conveying speed of the at least one product 6. The term “approximately the same speed” means that said speeds differ by maximum 30%, in some embodiments 10%, and in some embodiments 5%. Additionally, the direction of movement of the shuttle 10 is controlled in the transfer zone 5 to correspond to the direction of movement of the at least one product 6 on the infeed conveyor 3. For example, as schematically shown in FIG. 1, during the synchronizing time the shuttle vector S is essentially parallel to vector of the infeed movement trajectory Ti. The term “approximately the same direction” means that said directions are within a maximum angle, e.g., 1 to 5°, to each other. In some embodiments, between the shuttle 10 and the at least one product 6 the relative movement is zero, at least when the manipulator 2 picks the at least one product 6 off the infeed conveyor 3. The term “synchronize” excludes the scenario, wherein both the shuttle 10 and the at least one shuttle 6 are at a standstill.

The at least one product 6 is usually arranged in a random orientation and/or random position on the infeed conveyor 3. To synchronize the movement of the shuttle 10 to the movement of the at least one product 6 in the transfer zone 5, as mentioned, the infeed movement trajectory Ti of the at least one product 6 has to be known by the planar motor control unit 40. Therefore, in some embodiments, the pick and place system 1 further comprises a machine vision unit 11 and/or a sensor unit 12, which is arranged along the infeed conveyor 3 and/or in the transfer zone 5 (as exemplarily shown in FIG. 1 and FIG. 2).

The machine vision unit 11 and/or the sensor unit 12 are designed to determine the position of the at least one product 6 on the infeed conveyor 3 and the infeed movement trajectory Ti of the at least one product 6 on the infeed conveyor 3 being conveyed into the transfer zone 5 before the manipulator picks off the at least one product 6 from the infeed conveyor 3, when the pick and place system 1 is used. For example, the machine vision unit 11 comprises an imaging unit (e.g., a digital camera), an evaluation unit (e.g., a processor) and some kind of lighting means. The machine vision unit 11 images the at least one product 6 being conveyed on the infeed conveyor 3, in some embodiments before entering the transfer zone 5, and determines from the taken images the position of the at least one product 6 and especially its infeed movement trajectory Ti. Alternatively or additionally, the sensor unit 12, which comprises a number of sensors (e.g., position sensors), which can be arranged along the infeed conveyor 3 and/or in the transfer zone 5 to determine the infeed movement trajectory Ti of the at least one product 6 on the infeed conveyor 3 being conveyed into the transfer zone 5. Furthermore, the machine vision unit 11 and/or the sensor unit 12 can be designed to determine the orientation of the at least one product 6 on the infeed conveyor 3. To transfer said determined infeed movement trajectory Ti to the manipulator control unit 20 and/or the planar motor control unit 40, in some embodiments the machine vision unit 11 and/or the sensor unit 12 are connected to the manipulator control unit 20 and/or the planar motor control unit 40 via a suitable connection, e.g., wired or wireless (not shown in the figures).

Since the conveyor control unit 30 controls the drive unit of the infeed conveyor 3 to enable a certain conveying speed of the conveying means 13 and since the at least one product 6 is arranged on the conveying means 13, in some embodiments without any slipping, the conveying speed of the at least one product 6 on the infeed conveyor 3 corresponds to the conveying speed of the conveying means 13. Therefore, the conveying speed of at least one product 6 on the in-feed conveyor 3 is known and can be transmitted to the planar motor control unit 40, in order to determine the infeed movement trajectory Ti. The communication between the conveyor control unit 30 and the planar motor control unit 40 can be enabled by a suitable connection, e.g., via a wired connection (as indicated in FIG. 1) or via a wireless connection. Furthermore, due to the construction of the infeed conveyor 3 and the conveying means 13, the movement direction of the at least one product 6 is also known. For example, as shown in FIG. 1, the movement direction is along the x-direction.

However, these are just examples on how to determine the infeed movement trajectory Ti and a person skilled in the art could foresee other applicable methods. It highly depends on the circumstances of the application, which method is most practical.

The determined infeed movement trajectory Ti of the at least one product 6 on the infeed conveyor 3 can be used by the planar motor control unit 40 to control the movement of the shuttle 10 of outfeed planar motor 48. Furthermore, by knowing where the at least one product 6 is on the infeed conveyer 3 and how the at least one product 6 is orientated on the in-feed conveyer 3, as well as how the at least one product 6 is moved by the infeed conveyor 3 in the transfer zone 5, the shuttle 10 of the outfeed planar motor 48 can be moved above the infeed conveyor 3 (e.g., in the x-y plane) in the region of the at least one product 6 in the transfer zone 5 without colliding with said product 6.

The determined infeed movement trajectory Ti of the at least one product 6 can also be transmitted to the manipulator control unit 20. The manipulator control unit 20 can determine a pick position in the transfer zone 5 based on said known infeed movement trajectory Ti, in which pick position the at least one product 6 is picked off the infeed conveyor 3 by the manipulator 2. The pick position can also be transmitted to the planar motor control unit 40, so that the shuttle 10 of the outfeed planar motor 48 can be moved into the region of the pick position in the transfer zone 5 and in some embodiments be synchronized with the infeed movement trajectory Ti of the at least one product 6. Therefore, the manipulator control unit 20 is connected to the planar motor control unit 40 via a suitable connection, e.g., via a wireless or wired connection (as exemplary shown in FIG. 1). It is also possible, that the manipulator control unit 20 is connected to the conveyor control unit 30, to receive information, e.g., about the conveying speed of the conveying means 13.

Furthermore, the direction of movement and the speed of the shuttle 10 of the outfeed planar motor 48 and the direction of movement and the speed of the manipulator 2 in the transfer zone 5 can be controlled to be synchronized. For example, during the transfer synchronizing time, the shuttle 10 of the outfeed planar motor 48 is moved towards the manipulator 2 in the transfer zone 5 or the shuttle 10 of the outfeed planar motor 48 and the manipulator 2 in the transfer zone 5 are moved towards each other. To synchronize said relative movements, the manipulator control unit 20 can be connected to the planar motor control unit 40, to control the movement of the shuttle 10 of the outfeed planar motor 48 in the transfer zone 5. Therefore, the movement of the manipulator 2 can be defined as “master movement”, which in turn defines the movement of the shuttle 10 as “slave movement”. For example, the manipulator control unit 20 can determine a place position in the transfer zone 5, wherein the manipulator control unit 20 moves the manipulator 2 with the picked off product 6 to the determined place position. To place the picked off product 6 onto the shuttle 10 of the outfeed planar motor 48, the manipulator control unit 20 controls the movement of the shuttle 10 as well to move to the place position (overrules the planar motor control unit 40). It is also possible, that the movement of the shuttle 10 can be defined as “master movement”, which in turn defines the movement of the manipulator 2 as “slave movement”. For example, the planar motor control unit 40 defines the place position in the transfer zone 5, wherein the shuttle 10 is moved to said place position. The planar motor control unit 40 can further control the movement of the manipulator 2 (overrules the manipulator control unit 20), in that the manipulator 2 with the picked off product 6 is moved to the place position in order to place the at least one product 6 onto the shuttle 10 of the outfeed planar motor 48.

But these are just examples since depending on the specific application, defining the movement of the manipulator 2 or the movement of the shuttle 10 as the “master movement” can have certain advantages. However, the general aim is to synchronize their movements to enable a predefined relative movement in order to reduce the transfer time, hence the pick and place distance, as much as possible.

In some embodiments, the manipulator control unit 20, the conveyor control unit 30 and the planar motor control unit 40 are implemented in a single control unit of the pick and place system 1 (not shown). This can be advantageous in that all necessary information is gathered in the control unit in order to control the movements of the components of the pick and place system 1 in the transfer zone 5 and during transferring the at least one product 6.

In some embodiments, an outfeed shuttle bounding shape So is defined for the shuttle 10 of the outfeed planar motor 48. The outfeed shuttle bounding shape So encompasses the shuttle 10 of the outfeed planar motor 48 with a pick distance Pi between the outer circumference of the shuttle 10 of the outfeed planar motor 48 and the outfeed shuttle bounding shape So. The pick distance Pi may vary along the circumference of the shuttle 10. As exemplary shown in FIG. 1, the outfeed shuttle bounding shape So has a rectangular shape and is defined in the x-y plane. In some embodiments, the pick distance Pi is maximum a largest extension in one direction of the shuttle 10 of the outfeed planar motor 48. For example, the largest extension of the shuttle 10 in FIG. 1 is in x-direction or y-direction. Furthermore, a product zone 15 is formed between the outer circumference of the shuttle 10 of the outfeed planar motor 48 and the outfeed shuttle bounding shape So.

In some embodiments, the movement of the shuttle 10 of the outfeed planar motor 48 and/or the movement of the manipulator 2 is controlled to transfer the at least one product 6 to the shuttle 10 within the outfeed shuttle bounding shape So during the transfer time. Furthermore, in some embodiments, the shuttle 10 of the outfeed planar motor 48 is moved towards the at least one product 6, which is arranged in the product zone 15, before the manipulator 2 picks the at least one product 6 off the infeed conveyor 3 in said product zone 15. In some embodiments, when the manipulator 2 has picked off the at least one product 6, e.g., in z direction, at least by the height H of the shuttle 10, the shuttle 10 is moved towards the at least one product 6 picked off by the manipulator 2 or the shuttle 10 and the manipulator 2 with the picked off product 6 are moved towards each other, so that the pick and place distance is minimized. In some embodiments, the manipulator 2 only has to substantially move the product vertically in the z direction, at least by the height H of the shuttle 10, while picking the at least on product 6 off the infeed conveyor 3, wherein the shuttle 10 can be moved underneath the at least product 6 and the manipulator 2 can place the at least one product 6 onto the shuttle 10, substantially without any movement of the manipulator 2 in x and y direction. In this way, the transfer time is significantly decreased, since the required pick and place distance of the manipulator 2 is limited to only moving the at least one product 6 in z-direction. As a result, the operation speed of the pick and place system 1 can also be increased.

As already mentioned, after the at least one product 6 is picked off the infeed conveyor 3 by the manipulator 2, the manipulator 2 places the at least one product 6 onto the shuttle 10 of the outfeed planar motor 48. For example, the at least one product 6 is placed into a receptacle by the manipulator 2, which is arranged on the shuttle 10, e.g., a carton, a box or a case. It is also possible, that more than one product 6 can be placed onto the shuttle 10 of the out-feed planar motor by the manipulator 2. Therefore, the products 6 are picked off the infeed conveyor 3 and placed onto the shuttle 10 one by one by the manipulator 2, wherein the shuttle 10 can be moved to each of the products 6 (as already described) individually to minimize the pick and place distance. Alternatively, the products 6 are picked off the infeed conveyor 3 all at once by the manipulator 2 and placed onto the shuttle 10 by the manipulator 2 at the same time. After the manipulator 2 placed the at least one product 6 onto the shuttle 10, the shuttle 10 can be moved out of the transfer zone 5 (as exemplarily indicated in FIG. 1 along the conveying path 16).

After the basic components of the proposed pick and place system 1 have been outlined in detail with the embodiments shown in FIG. 1 and FIG. 2, in the following alternative embodiments of a pick and place system 1 according to the present disclosure will be described with FIG. 3 and FIG. 4. Basically, the operation of the pick and place system 1 is similar to the already explained arrangement shown in FIG. 1 and FIG. 2.

FIG. 3 shows an alternative embodiment of a pick and place system 1, wherein instead of the outfeed conveyor 4, the infeed conveyor 3 is designed as planar motor 8 and a shuttle 10 of the infeed planar motor 38 is designed to convey the at least one product 6 into the transfer zone 5. Of course, more than one product 6 can be arranged on the shuttle 10 of the infeed planar motor 38 and can be conveyed by said shuttle 10 into the transfer zone 5.

The outfeed conveyor 4 is designed as an industrial conveyor, e.g., as a belt conveyor. As described with FIG. 1, the belt of outfeed conveyor 4 as belt conveyor can also be arranged in the air gap between the shuttle 10 and the active surface of the stator 9 of the infeed planar motor 38. When the pick and place system 1 is used, the at least one product 6 is conveyed by the outfeed conveyor 4 out of the transfer zone 5 with a given outfeed movement trajectory To, after being placed onto the outfeed conveyor 4 by the manipulator 2. The outfeed movement trajectory To defines a direction of movement (path) and a conveying speed (dynamics) of the at least one product 6 on the outfeed conveyor 4 (similar to the already described infeed movement trajectory Ti).

As mentioned with the infeed conveyor 3 in FIG. 1 and FIG. 2, the conveyor control unit 30 can control the drive unit of the outfeed conveyor 4 and therefore the conveying speed of the conveying means 13. Hence, the conveying speed of the at least one product 6 on the out-feed conveyor 4 is known and can be transmitted to the planar motor control unit 40. Similar to the embodiment in FIG. 1, the communication between the conveyor control unit 30 and the planar motor control unit 40 can be enabled by a suitable connection, e.g., via a wired connection (as indicated in FIG. 3) or via a wireless connection. Furthermore, due to the construction of the outfeed conveyor 4 and the conveying means 13, the movement direction of the at least one product 6 can be predetermined. For example, as shown in FIG. 3, the movement direction is along the x-direction. In that way, the outfeed movement trajectory To can be determined, by which the at least one product 6 is moved out of the transfer zone 5 after being placed onto the outfeed conveyor 4. So, compared to FIG. 1 and FIG. 2, in case of this embodiment the machine vision unit 11 and/or the sensor unit 12 may not be needed. Therefore, the machine vision unit 11 and/or the sensor unit 12 are not shown in FIG. 3.

The infeed planar motor 38 is designed to synchronize the movement of the shuttle 10 of the infeed planar motor 38 in the transfer zone 5 to the outfeed movement trajectory To of the at least one product 6 in the transfer zone 5 at least when the manipulator 2 picks the at least one product 6 off the shuttle 10 of the infeed planar motor 38. Furthermore, in some embodiments, the infeed planar motor 38 is designed to synchronize the movement of the shuttle 10 of the infeed planar motor 38 in the transfer zone 5 to the outfeed movement trajectory To of the at least one product 6 in the transfer zone 5 for a given synchronizing time, when the pick and place system 1 is used, before the manipulator 2 picks the at least one product 6 off the shuttle 10 of the infeed planar motor 38.

In some embodiments, the infeed planar motor 38 is designed to synchronize the movement of the shuttle 10 of the infeed planar motor 38 in the transfer zone 5 to the movement of the manipulator 2 in the transfer zone 5 at least for a given transfer synchronizing time during the transfer time after the manipulator 2 has picked off the at least one product 6, when the pick and place system 1 is used. In some embodiments, during the transfer synchronizing time, the shuttle 10 of the infeed planar motor 38 is moved away from the manipulator 2 in the transfer zone 5.

As already described with the outfeed planar motor 48, the term “synchronize” basically means also in context of embodiments with the infeed planar motor 38, to control the movement of the shuttle 10 of the infeed planar motor 38 to achieve a predefined relative movement between said shuttle 10 and the outfeed movement trajectory To of the at least one product 6 in the transfer zone 5. In some embodiments, the shuttle 10 of the infeed planar motor 48 and the at least one product 6 move relative to each other in approximately the same direction and at approximately the same speed in the transfer zone 5. Furthermore, in some embodiments, the manipulator control unit 20 is connected to the planar motor control unit 40 of the infeed planar motor 38 and is designed to control the movement of the manipulator 2 and/or the movement of the shuttle 10 of the infeed planar motor 38 in the transfer zone 5. In some embodiments, the manipulator control unit 20 defines the movement of the manipulator 2 as the “master movement” in the transfer zone 5. For example, the pick position in the transfer zone 5 is defined by the manipulator control unit 20, wherein the shuttle 10 of the infeed planar motor 38 is moved to the pick position by the manipulator control unit 20. Furthermore, the manipulator control unit 20 can define a place position on the outfeed conveyor 4 in the transfer zone 5, wherein the manipulator unit 20 controls the movement of the shuttle 10 of the infeed conveyor 38, in that the shuttle 10 of the infeed planar motor 38 is moved away from the place position in the transfer zone 5.

In some embodiments, an infeed shuttle bounding shape Si is defined for the shuttle 10 of the infeed planar motor 38. The infeed shuttle bounding shape Si encompasses the shuttle 10 of the in-feed planar motor 38 with a place distance Po between the outer circumference of the shuttle 10 of the infeed planar motor 38 and the infeed shuttle bounding shape Si. As exemplary shown in FIG. 3, the infeed shuttle bounding shape Si has a rectangular shape and is defined in the x-y plane. In some embodiments, the place distance Po is maximum a largest extension in one direction of the shuttle 10 of the infeed planar motor 48. For example, the largest extension of the shuttle 10 in FIG. 3 is in x-direction or y-direction. Furthermore, a product zone 15 is formed between the outer circumference of the shuttle 10 of the infeed planar motor 38 and the infeed shuttle bounding shape Si.

The movement of the shuttle 10 of the infeed planar motor 38 and/or the movement of the manipulator 2 is controlled, in some embodiments by the manipulator control unit 20, to keep the at least one product 6 in the product zone 15 during the transfer time. In some embodiments, when the at least one product 6 is picked off the shuttle 10 of the infeed planar motor 38 by the manipulator 2, during the transfer time said shuttle 10 is moved away from the at least one product 6 picked off by the manipulator 2 or the shuttle 10 and the manipulator 2 with the picked off product 6 are move away from each other, so that the manipulator can place the product 6 onto the outfeed conveyor 4 in the product zone 15. In some embodiments, the manipulator 2 only has to substantially move the at least one product 6 a certain amount vertically in the z direction to transfer the at least one product, by picking the product 6 off the shuttle 10, wherein the shuttle 10 of the infeed planar motor 38 is moved away from underneath the picked off product 6 and by placing the at least one product 6 onto the outfeed conveyor 4 in the product zone 15 (substantially no movement in x and y direction). Of course, in some embodiments, the shuttle 10 of the infeed planar motor 38 is moved away from underneath the picked off product 6 in the product zone 15, so that the manipulator 2 can place said product 6 onto the outfeed conveyor without colliding with the shuttle 10.

After that, the at least one product 6 on the outfeed conveyor 4 is conveyed out of the transfer zone 5 with said outfeed movement trajectory To. Also, with this alternative embodiment of the proposed pick and place system 1, the transfer time is significantly decreased, since the required pick and place distance of the manipulator 2 is minimized. Therefore, the operation speed of the pick and place system 1 can be increased.

FIG. 4 shows yet another embodiment of a pick and place system 1 according to the present disclosure, wherein both the infeed conveyor 3 and the outfeed conveyor 4 are designed as planar motor 8. As exemplarily shown in FIG. 4, infeed planar motor 38 and the outfeed planar motor 48 adjoin each other in the transfer zone 5.

When the pick and place system 1 is used, the shuttle 10 of the infeed planar motor 38 as the infeed conveyor 3 conveys the at least one product 6 into the transfer zone 5 and the manipulator 2 transfers the at least one product 6 onto the shuttle 10 of the outfeed planar motor 48 as the outfeed conveyor 4. Since both the movement of the shuttle 10 of the infeed planar motor 38 and the movement of the shuttle 10 of the outfeed planar motor 48 can be controlled, in some embodiments by a respective planar motor control unit 40, the movement of the shuttle 10 of the infeed planar motor 38 and the movement of the shuttle 10 of the outfeed planar motor 48 are synchronized at least when the manipulator 2 picks the at least one product 6 off the shuttle 10 of the infeed planar motor 38. Therefore, both planar motor control units 40 can be connected to each other, as exemplarily shown in FIG. 4. In case of this embodiment the machine vision unit 11 and/or the sensor unit 12 may also not be needed. Therefore, the machine vision unit 11 and/or the sensor unit 12 are not shown in FIG. 4.

In some embodiments, the movement of the shuttle 10 of the infeed planar motor 38 in the transfer zone 5 is synchronized to the movement of the manipulator 2 in the transfer zone 5 for the given synchronizing time before the manipulator 2 picks the at least one product 6 off the shuttle 10 of the infeed planar motor 38. Therefore, the manipulator control unit 20 can be connected to the planar motor control unit 40 of the infeed planar motor 38, to control the movement of the shuttle 10 of the infeed planar motor 38, in that the shuttle 10 is moved to a predefined pick position in the transfer zone 5 by the manipulator control unit 20.

Furthermore, after the manipulator 2 has picked the at least one product 6 off the shuttle 10 of the infeed conveyor 38, during the transfer time the movement of the shuttle 10 of the in-feed planar motor 38 and/or the movement of the shuttle 10 of the outfeed planar motor 48 in the transfer zone 5 is synchronized to the movement of the manipulator 2 in the transfer zone 5 at least for the given transfer synchronizing time. During the transfer synchronizing time the shuttle 10 of the outfeed planar motor 48 is moved towards the manipulator 2 in the transfer zone 5 and/or in that during the transfer synchronizing time the shuttle 10 of the infeed planar motor 38 is moved away from the manipulator 2 in the transfer zone 5. Therefore, the manipulator control unit 20 can be connected to the planar motor control unit 40 of the outfeed planar motor 38 as well, to not only control the movement of the shuttle 10 of the infeed planar motor 38, but also the movement of the shuttle 10 of the outfeed planar motor 48.

In some embodiments, during the transfer time, a shuttle distance D between the outfeed shuttle bounding shape So, which corresponds to the circumference of the shuttle 10 of the out-feed planar motor 48, and the infeed shuttle bounding shape Si, which corresponds to the circumference of the shuttle 10 of the infeed planar motor 38, is kept between the given minimum pick-and-place distance and the given maximum pick-and-place distance, wherein said shuttle distance D is between zero and the largest extension in one direction of the outfeed shuttle bounding shape So or the infeed shuttle bounding shape Si.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

In the claims:

1. A pick and place system for transferring products, comprising: a manipulator, an infeed conveyor and an outfeed conveyor,
wherein at least the infeed conveyor or the outfeed conveyor is designed as a planar motor comprising at least one shuttle, which at least one shuttle is moveable in a transfer zone of the pick and place system,
wherein when the pick and place system is used, at least one product is arranged on the infeed conveyor and the at least one product is conveyed by the infeed conveyor into the transfer zone,
wherein the manipulator is moveable in the area of the transfer zone and the manipulator is provided to pick the at least one product off the infeed conveyor, to move the at least one product to the outfeed conveyor and to place the at least one product onto the outfeed conveyor during a transfer time when the pick and place system is used,
wherein the outfeed conveyor comprises a planar motor, wherein:
when the pick and place system is used, the at least one product is conveyed on the infeed conveyor into the transfer zone with a given infeed movement trajectory and the shuttle of the outfeed planar motor is moved in the transfer zone in the region of the at least one product on the infeed conveyor, and
wherein the outfeed planar motor is configured designed to synchronize the movement of the shuttle of the outfeed planar motor in the transfer zone to the infeed movement trajectory of the at least one product in the transfer zone at least when the manipulator picks the at least one product off the infeed conveyor,
or wherein the infeed conveyor comprises a planar motor and the shuttle of the infeed planar motor is configured to convey the at least one product into the transfer zone, wherein;
when the pick and place system is used, the at least one product is conveyed by the outfeed conveyor out of the transfer zone with a given out-feed movement trajectory after being placed onto the outfeed conveyor by the manipulator, and
the infeed planar motor is configured to synchronize the movement of the shuttle of the infeed planar motor in the transfer zone to the outfeed movement trajectory of the at least one product in the transfer zone at least when the manipulator picks the at least one product off the shuttle of the infeed planar motor.

2. The pick and place system according to claim 1, wherein the outfeed planar motor is configured to synchronize the movement of the shuttle of the outfeed planar motor in the transfer zone to the infeed movement trajectory of the at least one product in the transfer zone for a given synchronizing time, when the pick and place system is used, before the manipulator picks the at least one product off the infeed conveyor.

3. The pick and place system according to claim 1, wherein the infeed planar motor is configured to synchronize the movement of the shuttle of the infeed planar motor in the transfer zone to the outfeed movement trajectory of the at least one product in the transfer zone for a given synchronizing time, when the pick and place system is used, before the manipulator picks the at least one product off the shuttle of the infeed planar motor.

4. The pick and place system according to claim 1, wherein:
the outfeed planar motor is configured to synchronize the movement of the shuttle of the outfeed planar motor in the transfer zone to the movement of the manipulator in the transfer zone at least for a given transfer synchronizing time during the transfer time after the manipulator has picked off the at least one product when the pick and place system is used, or
the infeed planar motor is configured to synchronize the movement of the shuttle of the infeed planar motor in the transfer zone to the movement of the manipulator in the transfer zone at least for a given transfer synchronizing time during the transfer time after the manipulator has picked off the at least one product when the pick and place system is used.

5. The pick and place system according to claim 1, wherein the pick and place system further comprises a control unit, which is configured to control the movement of the manipulator and/or the movement of the shuttle of the infeed planar motor and/or the movement of the shuttle of the outfeed planar motor in the transfer zone.

6. A method for operating a pick and place system for transferring products with a manipulator between an infeed conveyor and an outfeed conveyor,
wherein at least one product is arranged on the infeed conveyor and the at least one product is conveyed by the infeed conveyor into a transfer zone of the pick and place system, in which transfer zone during a transfer time the manipulator picks the at least one product off the infeed conveyor, moves the at least one product to the outfeed conveyor and places the at least one product onto the outfeed conveyor, and
wherein the at least one product is conveyed by the outfeed conveyor out of the transfer zone,
wherein the outfeed conveyor comprises a is as planar motor and the at least one product is conveyed on the infeed conveyor into the transfer zone with a given infeed movement trajectory, wherein:
the shuttle of the outfeed planar motor is moved in the transfer zone in the region of the at least one product on the infeed conveyor, and
wherein the movement of the shuttle of the outfeed planar motor in the transfer zone is synchronized to the infeed movement trajectory of the at least one product in the transfer zone at least when the manipulator picks the at least one product off the infeed conveyor,
or wherein the infeed conveyor comprises a planar motor and the at least one product is conveyed on the shuttle of the infeed planar motor into the transfer zone and the at least one product is conveyed by the outfeed conveyor out of the transfer zone with a given outfeed movement trajectory after being placed onto the outfeed conveyor by the manipulator,
wherein the movement of the shuttle of the infeed planar motor in the transfer zone is synchronized to the outfeed movement trajectory of the at least one product in the transfer zone at least when the manipulator picks the at least one product off the shuttle of the infeed planar motor.

7. The method according to claim 6, wherein the movement of the shuttle of the outfeed planar motor in the transfer zone is synchronized to the infeed movement trajectory of the at least one product in the transfer zone for a given synchronizing time before the manipulator picks the at least one product off the infeed conveyor.

8. The method according to claim 6, wherein the movement of the shuttle of the infeed planar motor in the transfer zone is synchronized to the outfeed movement trajectory of the at least one product in the transfer zone for a given synchronizing time before the manipulator picks the at least one product off the shuttle of the infeed planar motor.

9. The method according to claim 6, wherein after the manipulator has picked off the at least one product, during the transfer time the movement of the shuttle of the infeed planar motor or the movement of the shuttle of the out-feed planar motor in the transfer zone is synchronized to the movement of the manipulator in the transfer zone at least for a given transfer synchronizing time.

10. The method according to claim 9, wherein during the transfer synchronizing time the shuttle of the outfeed planar motor is moved towards the manipulator in the transfer zone, or in that wherein during the transfer synchronizing time the shuttle of the infeed planar motor is moved away from the manipulator in the transfer zone.

11. The method according to claim 6, wherein:
the outfeed conveyor comprises a planar motor and the infeed conveyor is designed as planar motor,
an outfeed shuttle bounding shape is defined for the shuttle of the outfeed planar motor, said the outfeed shuttle bounding shape encompasses the shuttle of the outfeed planar motor, and an infeed shuttle bounding shape is defined for the shuttle of the infeed planar motor, said the infeed shuttle bounding shape encompasses the shuttle of the infeed planar motor, and
during the transfer time a shuttle distance between the outfeed shuttle bounding shape and the infeed shuttle bounding shape is kept between a given minimum pick-and-place distance and a given maximum pick-and-place distance, and
the shuttle distance is preferably between zero and a largest extension in one direction of the outfeed shuttle bounding shape or the infeed shuttle bounding shape.

12. The method according to claim 6, wherein:
the outfeed conveyor comprises a is designed as planar motor,
in that an outfeed shuttle bounding shape is defined for the shuttle of the outfeed planar motor, said the outfeed shuttle bounding shape encompasses the shuttle of the outfeed planar motor with a pick distance between the outer circumference of the shuttle of the outfeed planar motor and the outfeed shuttle bounding shape so that a product zone is formed between the outer circumference of the shuttle of the outfeed planar motor and the outfeed shuttle bounding shape,
the pick distance is preferably maximum a largest extension in one direction of the shuttle of the outfeed planar motor, and
the movement of the shuttle of the outfeed planar motor and/or the movement of the manipulator is controlled to transfer the at least one product to the shuttle within the outfeed shuttle bounding shape during the transfer time.

13. The method according to claim 12, wherein:
the shuttle of the outfeed planar motor is moved towards the at least one product in the product zone before the manipulator picks the at least one product off the infeed conveyor in said product zone, and
after the at least one product is picked off the infeed conveyor by the manipulator, the manipulator places the at least one product onto the shuttle of the outfeed planar motor.

14. The method according to claim 6, wherein:
the infeed conveyor comprises a planar motor,
an infeed shuttle bounding shape is defined for the shuttle of the infeed planar motor, said the infeed shuttle bounding shape encompasses the shuttle of the infeed planar motor with a place distance between the outer circumference of the shuttle of the infeed planar motor and the infeed shuttle bounding shape so that a product zone is formed between the outer circumference of the shuttle of the infeed planar motor and the infeed shuttle bounding shape,
the place distance is preferably maximum a largest extension in one direction of the shuttle of the infeed planar motor, and
the movement of the shuttle of the infeed planar motor and/or the movement of the manipulator is controlled to keep the at least one product in the product zone during the transfer time.

15. The method according to claim 6, wherein in the transfer zone the movement of the manipulator and/or the movement of the shuttle of the infeed planar motor and/or the movement of the shuttle of the outfeed planar motor is controlled by a control unit of the pick and place system.
